(19) United States
(12) Patent Application Publication
(10) Pub. No.: US 2002/0044203 A1
(43) Pub. Date: Apr. 18, 2002

(54) Method and system for participating in remote events

(76) Inventor: Itzhak Sapir, Irvine, CA (US)

Correspondence Address: Itzhak Sapir, 27, Foxhill St., Irvine, CA, 92604, US

(21) Appl. No.: 09/981,068

(22) Filed: Oct. 15, 2001

Related U.S. Application Data
(60) Provisional application No. 60/241,239, filed on Oct. 17, 2000.

(51) Int. Cl. H04N 7/18

(52) U.S. Cl. 348/143; 725/105; 348/152; 340/500; 340/540; 340/541

(57) ABSTRACT

A system and method that will allow individuals and groups to be a part (either passive using a unidirectional system or active with a bi-directional system) of events that happen in a remote place at the same time these events happen.

The proposed system consists of three major parts:

The sensing platform—A platform that contains one or more sensing devices (cameras, microphones, motion and acceleration sensors etc.) and that is positioned at the site of the monitored event

The reproduction platform/platforms—One or more platforms, each containing one or more systems for reproducing certain parts of the monitored event (displays, VR goggles, headphones, loudspeakers, moving chairs etc.). The platform/platforms are to be positioned in places were the reproduction of the event is wanted

The communication system—A system that will transfer the data received from the sensors in the sensing platform to the reproduction systems in the reproduction platforms at the required data rate for allowing real time reproduction of the monitored event.

The method and system are mainly aimed at the entertainment and virtual travel markets but can be used for education, research and other areas.

### BACKGROUND OF THE INVENTION

1. Field of the invention

The invention relates to methods and systems for acquisition of real life events' data in one location and transmission of this data to another location for use at this location.

2. Description of the related art

Currently there are systems that allow transmission of data acquired by sensors in one location to another location for reproduction at that new location. These systems include television broadcasting, surveillance systems (with cameras, microphones etc.) and other such systems. Several systems have capabilities such as capture and transmission of 3-D images, multi directional sound acquisition and even sensing and transmitting of smell data. These acquisition systems are passive. The do not participate in the event and do not have a bidirectional interaction with the event. The event's course of action is not influenced by the existence of TV cameras and surveillance systems and any such monitoring systems. In addition, these systems usually offer sound and vision capture only.

Independently, there are systems for reproduction of pre-programmed actions and user controlled actions such as computer and arcade games and simulators including those that have actuators that add motion to the reproduction experience. These systems are not combined with real life events' acquisition systems and usually contain artificial imitation of real life events. At this time, no system offers a multi-sensory, event involved, capture and reproduction of real life events.

### BRIEF SUMMARY OF THE INVENTION

The present invention is a system and method that allows individuals and groups to participate in a multi-sensory experience (either passive using a unidirectional system or active with a bidirectional system) that receives inputs from, and interacts with real life events that happen in remote places.

The proposed system consists of three major parts:

The sensing platform—A platform that contains on or more sensing devices (cameras, microphones, motion sensors etc.) and that is positioned at the site of the monitored event

The reproduction platform/platforms—One or more platforms, each containing one or more systems for reproducing certain parts of the monitored event (displays, VR goggles, headphones, loudspeakers, moving chairs etc.). The platform/platforms are to be positioned in places were the reproduction of the event is wanted

The communication system—A system that transfers the data received from the sensors in the sensing platform to the reproduction systems in the reproduction platforms at the required data rate for allowing real time reproduction of the monitored event.

The method and system are mainly aimed at the entertainment and virtual travel markets but can be used for education, research and other areas.

Key features of the present invention are multi-sensory capture of real life events with an event-involved platform and multi-sensory reproduction of these events with one or more reproduction systems.

### BRIEF DESCRIPTION OF THE SEVERAL VIEWS OF THE DRAWING

Not applicable

### DETAILED DESCRIPTION OF THE INVENTION

The present invention is a system and method that allows individuals and groups to participate in a multi-sensory experience (either passive using a unidirectional system or active with a bi-directional system) that receives inputs from, and interacts with real life events that happen in remote places. The method and system are mainly aimed at the entertainment and virtual travel markets but can be used for education, research and other areas.

System description

The proposed system consists of three major parts:

The sensing platform—A platform that contains on or more sensing devices (cameras, microphones, motion sensors etc.) and that is positioned at the site of the monitored event. This platform can be a dedicated one, especially designed to work with the system (examples: a bus fall of sensors of all kinds—cameras pointing to all directions, acceleration sensors, microphones, smell sensors—that travels in a popular tourism area, or a boat with sensors, traveling downstream in a wild whitewater rafting experience). The sensing platform can also be a one-time, non-dedicated, platform such as a mountain climber that is equipped with all the necessary sensors that capture his experience, or a racing car or motorcycle that is equipped with sensors and captures all the motion and visual aspects of the event in the way the driver or rider experiences them. An example of another type of a non-dedicated platform can be a wild animal in its natural environment equipped with sensors such as tiny cameras, microphones and motion sensors. It needs to be understood that the sensing platform exists and performs in real life and real time. A tour bus actually travels along its route with a driver and a tour guide; the whitewater raft really goes through all the waterfalls with the risk of rolling over, etc.

The reproduction platform/platforms—One or more platforms, each containing one or more systems for reproducing certain parts of the monitored event (displays, VR goggles, headphones, loudspeakers, moving chairs etc.). The platform/platforms are to be positioned in places were the reproduction of the event is wanted. Unlike the sensing platform that is one and unique for each event, there can be many reproduction platforms, allowing as many individuals and groups as desired to participate in and experience an event at the same time. The reproduction platform is designed to allow best reproduction of the captured event. It is generally, but not necessarily, a type of a simulator that can reproduce the motion, sound, views, touch and maybe even smells (using new and emerging technologies). In some cases it looks from the inside and outside, exactly like the sensing platform—a bus, a boat, a car or a motorcycle. In other cases, the reproduction platform can be a suit dressed by a person with many actuators and reproduction means such as VR goggles that allows the user to feel what the person that acts as the sensing platform feels. The reproduction experience can combine a platform that serves a group with personal gear for each participant for more personalized experience. The reproduction platform also consists of a computer system that processes the information coming from the sensing platform and from the user controls in order to send every user only the information he requires (for example: if there are many cameras in the sensing platform that cover a large (even 360 degree spherical) field of view, the user may use a tracking device mounted on his head along with VR goggles to get only the view in the direction that he is looking at. The reproduction platform may also include special effects means such as water sprinklers and hoses in the case of the whitewater raft and heaters for reproducing heat when required. For reproducing the scenery received from the sensing platform, the reproduction platform may also include all kinds of display systems, VR goggles as mentioned, projection on walls, privately viewed TV screens, holograms, 3D images and more.

The communication system—A system that transfers the data received from the sensors in the sensing platform to the reproduction systems in the reproduction platforms at the required data rate for allowing real time reproduction of the monitored event. By the nature of the proposed system, this needs to be a broad band system that is capable of handling the amount of information that is simultaneously transferred between the sensing and reproduction platforms. The communication system may be one or a combination of different types. It may be wired or wireless, direct (point to point) or networked, digital or analog. It can be internet based or have the Internet as a part of it. It can also be based on any other existing or future computer and data network system. As an option, the communication system may include a large enough buffer for storage of incoming data in order to maintain good quality stream of data to the reproduction platform in the cost of a short delay between the event timing and the reproduction timing. (This buffer may be a part of the sensing or the reproduction platforms).

Bi-directional system

A system that allows inputs received from the reproduction platform to be transferred and used in the sensing platform. In the case of a bi-directional system, the user, while in the reproduction platform, will be able to actively participate in an event by sending commands back to the sensing platform. The sensing platform will have response capabilities to the commands (example: participation in a real car race using an unmanned, remotely operated, full sensory race car).

System use

The major ideas behind the proposed system are real life with active involvement of the sensing platform in the event and multi-sensory (as many as possible human senses participating in the experience) reproduction of the event in a desired location. This combination makes such an experience, a controlled “adventure”. (For example: the whitewater raft may roll over in real life with all the passengers thrown into the water. In this case the reproduction platform will roll over (if so designed) and throw the virtual passengers into the shallow water around it).

Some potential uses for such a system:

Participation in sports events from an inside point of view and with all possible senses.

Participation in very unique events that otherwise are out of reach for most people (seating in an astronaut seat during the launch of the space shuttle, going into an active volcano with a multi sensory unmanned device and more)

World wide tourism while in your home town

A lesson where students located in different places or located in one place remotely from the event, can participate in an event that takes place in a location that demonstrates the best the subject of this lesson.

I claim:

1. A system and method for capture and reproduction of real life events comprising of a sensing platform with one or more sensors, at least one reproduction platform with means for reproducing an action or actions captured by the sensing platform and a communication system for transferring the data from said sensing platform to said reproduction platform. Said sensing platform actively participates in the event of interest by having a bidirectional interaction between the event and said sensing platform. Said reproduction platform is positioned in a place where the event reproduction is wanted. Said communication system transfers the data captured by said sensing platform to said reproduction platform.

2. A system according to claim 1 and wherein at least one of the sensors in said sensing platform is one of the following: a camera, a 3-D camera, a sound pickup device, a motion sensor, an acceleration sensor, a smell pickup device, a touch sensor.

3. A system according to claim 1 and wherein there is a buffer or data storage device in the data stream path to allow for a delay between the time the data is captured in said sensing platform and the time it is being used for reproduction of the event in said reproduction platform.

4. A system according to claim 1 and wherein there is a bi-directional data transfer between said sensing platform and said reproduction platform and wherein control commands and actions, captured in said reproduction platform are transferred to said sensing platform to control or change one or more of said sensing platform's actions.

5. A system according to claim 1 and wherein said communication system is one of the following: wired, wireless, directly connects said sensing platform to said reproduction platform, uses commercial and other available network systems, uses the internet.

6. A system and method for capture and reproduction of real life events comprising of a sensing platform with one or more sensors, at least one reproduction platform with means for reproducing an action or actions captured by the sensing platform and a communication system for transferring data from said sensing platform to said reproduction platform. Said sensing platform actively participates in the event of interest by having a bidirectional interaction between the event and said sensing platform. Said sensing platform includes at least one of the following sensors: a motion sensor, an acceleration sensor, a smell pickup device or a touch sensor. Said reproduction platform is positioned in a place where the event reproduction is wanted. Said communication system transfers the data captured by said sensing platform to said reproduction platform.

7. A system according to claim 6 and wherein there is a buffer or data storage device in the data stream path to allow for a delay between the time that the data is captured in said sensing platform and the time it is being used for reproduction of the event in said reproduction platform.

8. A system according to claim 6 and wherein there is a bi-directional data transfer between said sensing platform and said reproduction platform and wherein control commands and actions captured in said reproduction platform are transferred to said sensing platform to control or change one or more of said sensing platform's actions.

9. A system according to claim 6 and wherein said communication system is one of the following: wired, wireless, directly connects said sensing platform to said reproduction platform, uses commercial and other available network systems, uses the internet.

10. A system and method for capture and reproduction of real life events comprising of a sensing platform with one or more sensors, at least one reproduction platform with means for reproducing an action or actions captured by the sensing platform and a communication system for transferring data from said sensing platform to said reproduction platform. Said sensing platform actively participates in the event of interest by having a bi-directional interaction between the event and said sensing platform. Said reproduction platform is positioned in a place where the event reproduction is wanted. Said reproduction platform consists of at least one reproduction means of the following: a smell reproduction device, a motion actuator, an actuator in an object to be touched, an actuator installed in a clothing item. Said communication system transfers the data captured by said sensing platform to said reproduction platform.

11. A system according to claim 10 and wherein at least one of the reproduction means in said reproduction platform is one of the following: a display, a personal display device, a loudspeaker, headphones.

12. A system according to claim 10 and wherein there is a buffer or data storage device in the data stream path to allow for a delay between the time that the data is captured in said sensing platform and the time it is being used for reproduction of the event in said reproduction platform.

13. A system according to claim 10 and wherein there is a bi-directional data transfer between said sensing platform and said reproduction platform and wherein control commands and actions captured in said reproduction platform are transferred to said sensing platform to control or change one or more of said sensing platform's actions.

14. A system according to claim 10 and wherein said communication system is one of the following: wired, wireless, directly connects said sensing platform to said reproduction platform, uses commercial and other available network systems, uses the internet, digital, analog.
